(19) United States
(12) Patent Application Publication
(10) Pub. No.: US 2006/0231730 A1
(43) Pub. Date: Oct. 19, 2006

(54) Focus detection apparatus

(75) Inventor: Hirofumi Miyamoto, Niiza-shi (JP)

Correspondence Address: Scully, Scott, Murphy & Presser, 400 Garden City Plaza, Garden City, NY, 11530-3319, US

(73) Assignee: OLYMPUS CORPORATION, Tokyo (JP)

(21) Appl. No.: 11/403,068

(22) Filed: Apr. 12, 2006

(30) Foreign Application Priority Data
Apr. 14, 2005 (JP) 2005-117173

(51) Int. Cl. G01B 9/04

(52) U.S. Cl. 250/201.8

(57) ABSTRACT

Arranging a pinhole immediately front a two-split photodetector and condensing reflected light transmitted through the pinhole on the two-split photodetector cut off a part of a light receiving spot S when a focal position largely deviates from light receiving surfaces of the two-split photodetector, thereby restricting a quantity of light detected by the two-split photodetector.

### CROSS-REFERENCE TO RELATED APPLICATIONS

This application is based upon and claims the benefit of priority from prior Japanese Patent Application No. 2005-117173, filed Apr. 14, 2005, the entire contents of which are incorporated herein by reference.

### BACKGROUND OF THE INVENTION

1. Field of the Invention

The present invention relates to a focus detection apparatus applied to an optical apparatus which performs observation, measurement and examination of a sample by using an optical system.

2. Description of the Related Art

In recent years, an optical apparatus, especially a microscope tends to be extensively used in a process such as observation, measurement, examination or the like of a product in an industrial field. It is very important for such a microscope to be capable of efficiently performing focus detection with respect to a sample in order to improve throughput of a process.

FIG. 10 shows an example of a configuration of a conventional focus detection apparatus. A laser beam emitted from a laser diode (LD) 101 is transmitted through a collimator lens 102 to turn to a parallel light beam. A half of this laser beam is prevented from being transmitted by a restriction edge 103 arranged in a light path. The remaining half of the laser beam which has not been prevented from being transmitted is applied to a polarizing beam splitter 104. A light beam reflected by the polarizing beam splitter 104 is transmitted through a ¼ wave plate 105 and an object lens 106 to be condensed on a surface 108 of a sample 107. At this time, the laser beam passes through a light path illustrated on a right-hand side with respect to an optical axis in the drawing. The laser beam is reflected by the surface 108 of the sample 107. The reflected light passes through a light path on a left-hand side in the drawing with respect to the optical axis, and is again transmitted through the object lens 106 and the ¼ wave plate 105 to be applied to the polarizing beam splitter 104. The reflected light transmitted through the polarizing beam splitter 104 is condensed on a light receiving surface of a two-split photodetector 111 through a condenser lens 110 (a condensing position point R).

It is to be noted that reflected light other than the above-described reflected light is generated when the laser beam is reflected after being condensed on the surface 108 of the sample 107. This reflected light is generated by, e.g., diffuse reflection caused due to roughness of the surface 108 of the sample 107 or an inclination of the mounted sample 107. However, such reflected light is prevented from being transmitted by a restriction edge 109.

The two-split photodetector 111 includes two light receiving surfaces J and K, and each of these light receiving surfaces J and K is provided with a function of outputting a current signal corresponding to each quantity of detected light. The current signal output from each of these light receiving surfaces J and K is supplied to a non-illustrated current/voltage conversion circuit. The current signal is converted into a voltage signal by the current/voltage conversion circuit, and then output as the voltage signal corresponding to a quantity of detected light.

FIG. 11A shows characteristics of changes in voltage signals J and K output from the two light receiving surfaces J and K of the two-split photodetector 111 when a horizontal axis represents a position of the sample 107. Voltage signals JS and KS having such characteristics of changes are respectively input to corresponding focus detecting portions (not shown), and a predetermined calculation is performed, thereby outputting a focus detection signal. FIG. 11B shows signal characteristics obtained from results of calculations performed with respect to the voltage signals JS and KS. The focus detection signal can be acquired from the signal characteristics. In FIG. 11B, a dotted light L indicates signal characteristics obtained from a result of calculating (JS−KS)/(JS+KS), and a solid line M indicates signal characteristics obtained from a result of calculating (JS−KS). Each of these two signal characteristics has an S shape as depicted in the drawing, and the focus detection signal is obtained based on a zero cross signal of the signal characteristics L and M having such S-shaped characteristics, and a focal position is calculated from this focus detection signal.

Further, based on this result, a non-illustrated control portion controls a focusing mechanism 112 depicted in FIG. 10. As a result, a stage 113 moves up and down, and the sample 107 is moved to a focal position.

Furthermore, in such a focus detection apparatus, for example, a method mentioned below is put to practical use in order to increase a speed of focus detection. In FIG. 1C, a solid line N indicates signal characteristics obtained from a result of adding the voltage signals JS and KS. The control portion detects a range not smaller than a voltage level P (which is determined as a section Q) in the signal characteristics N. This range, i.e., a range of the section Q at a position of the sample 107 represented by a horizontal axis is recognized as a focal point proximity range. Moreover, the control portion drives the focusing mechanism 112 at a low speed to perform fine adjustment in this focal point proximity range, and drives the focusing mechanism 112 at a high speed outside this range, i.e., outside the focal point proximity range (the section Q), thereby performing focus detection at a high accuracy and a high speed.

Meanwhile, states of a light receiving spot on the light receiving surfaces J and K of the two-split photodetector 111 at respective points t, u, w, x and y on the solid line N depicted in FIG. 11C are as shown in FIGS. 12A to 12E. FIG. 12A shows a state of the light receiving spot at the point t where a focal position largely inwardly deviates from the light receiving surfaces J and K, and a size of the light receiving spot S is greatly larger than the light receiving surface K. FIG. 12B shows a state of the light receiving spot S at the point u where a focal position slightly inwardly deviates from the light receiving surfaces J and K, and a size of the light receiving spot S fits in the light receiving surface K. FIG. 12C shows a state of the light receiving spot at the point w where a focal position is placed on the light receiving surfaces J and K, and a size of the light receiving spot S is minimum and placed on both the light receiving surfaces J and K. Additionally, FIG. 12D shows a state of the light receiving spot at the point x where a focal position slightly outwardly deviates from the light receiving surfaces J and K, and a size of the light receiving spot S fits in the light receiving surface J. Further, FIG. 12E shows a state of the light receiving spot at the point y where a focal position largely outwardly deviates from the light receiving surfaces J and K, and a size of the light receiving spot S is greatly larger than the light receiving surface J.

Therefore, based on these relationships, the focal point proximity range (the section Q) is determined. Accordingly, the relationship between sizes of the light receiving surfaces J and K and a size of the light receiving spot S is important. If the light receiving surfaces J and K of the two-split photodetector 111 are larger than the light receiving spot S beyond necessity in these relationships, the focal point proximity range (the section Q) becomes unnecessarily wide. As a result, a range in which the focusing mechanism 112 is driven at a low speed is increased, and movement to a focal position may possibly take time. Furthermore, the focal point proximity range (the section Q) differs depending on characteristics of the object lens (e.g., a type of the lens (a magnifying power of the lens and focal length)) or characteristics of the sample 107 (e.g., a reflection factor or a shape of a surface). Therefore, focus detection may possibly take time when, e.g., a magnifying power of the object lens is switched.

### BRIEF SUMMARY OF THE INVENTION

According to one aspect of the present invention, there is provided a focus detection apparatus in which a sample is irradiated with light emitted from a light source along one of two divided regions on a plane vertical to an optical axis of an object lens, light reflected from the sample along the other region is detected by a light receiving portion having a plurality of light receiving surfaces, and focus detection is performed based on a quantity of light detected by the plurality of light receiving surfaces of the light receiving portion, the focus detection apparatus comprising a light receiving quantity restricting portion which restricts a light quantity of reflected light from the sample when the light receiving portion detected the light quantity.

In the present invention, there is provided the focus detection apparatus which can perform focus detection at a high speed (a short time) and a high accuracy by optimizing a size of each light receiving surface of a split element and a size of a light receiving spot.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a schematic structure of a focus detection apparatus according to a first embodiment of the present invention;

FIG. 2A is a view showing a state of a light receiving spot S when a focal position largely inwardly deviates from light receiving surfaces of a two-split photodetector and a size of the light receiving spot S is larger than a pinhole, FIG. 2B is a view showing a state of the light receiving spot S when a focal position slightly inwardly deviates from the light receiving surfaces of the two-split photodetector and a size of the light receiving spot S fits in the pinhole, FIG. 2C is a view showing a state of the light receiving spot S when a focal position is placed on the light receiving surfaces of the two-split photodetector and a size of the light receiving spot S is minimum and runs through a central part of the pinhole, FIG. 2D is a view showing a state of the light receiving spot S when a focal position slightly outwardly deviates from the light receiving surfaces of the two-split photodetector and a size of the light receiving spot S fits in the pinhole, and FIG. 2E is a view showing a state of the light receiving spot S when a focal position largely outwardly deviates from the light receiving surfaces of the two-split photodetector and a size of the light receiving spot S is larger than the pinhole;

FIG. 3A is a view showing a state where the pinhole cuts off a part of the light receiving spot S to restrict a light beam which enters the two-split photodetector and the light beam transmitted through the pinhole is detected by a light receiving surface K, FIG. 3B is a view showing a state where the pinhole allows transmission of all of the light receiving spot S and the light beam transmitted through the pinhole is detected by the light receiving surface K, FIG. 3C is a view showing a state where the pinhole allows transmission of all of the light receiving spot S and the light beam transmitted through the pinhole is detected by the light receiving surfaces J and K, FIG. 3D is a view showing a state where the pinhole allows transmission of all of the light receiving spot S and the light beam transmitted through the pinhole is detected by the light receiving surface J, and FIG. 3E is a view showing a state where the pinhole cuts off a part of the light receiving spot S to restrict the light beam which enters the two-split photodetector and the light beam transmitted through the pinhole is detected by the light receiving surface J;

FIG. 4 is a view showing signal characteristics obtained from a result of adding voltage signals JS and KS according to a first embodiment;

FIG. 5A is a view showing a modification of the pinhole having a square hole provided thereto, FIG. 5B is a view showing a modification of the pinhole having a rectangular hole provided thereto, and FIG. 5C is a view showing a modification of the pinhole having an elliptic hole provided thereto;

FIG. 6 is a view showing a schematic structure of a four-split photodetector used in a second embodiment according to the present invention;

FIG. 7 is a view showing a schematic structure of a detection circuit used in the second embodiment;

FIG. 8 is a view showing a schematic structure of a four-split photodetector according to a modification of the second embodiment;

FIG. 9 is a view showing a schematic structure of a primary part of a focus detection apparatus according to a third embodiment of the present invention;

FIG. 10 is a view showing a schematic structure of an example of a conventional focus detection apparatus;

FIG. 11A is a view showing change characteristics of voltage signals J and K output from two light receiving surfaces J and K of the two-split photodetector in the conventional focus detection apparatus when a horizontal axis represents a position of a sample, FIG. 11B is a view showing signal characteristics obtained from a result of performing calculation with respect to voltage signals JS and KS in the conventional focus detection apparatus, and FIG. 11C is a view showing signal characteristics obtained from a result of adding the voltage signals JS and KS in the conventional focus detection apparatus; and

FIG. 12A is a view showing a state of a light receiving spot at a point t where a focal position largely inwardly deviates from the light receiving surfaces J and K in the conventional focus detection apparatus and a size of the light receiving spot S is greatly larger than the light receiving surface K, FIG. 12B is a view showing a state of the light receiving spot at a point u where a focal position slightly inwardly deviates from the light receiving surfaces J and K in the conventional focus detection apparatus and a size of the light receiving spot S fits in the light receiving surface K, FIG. 12C is a view showing a state of the light receiving spot at a point w where a focal position is placed on the light receiving surfaces J and K and a size of the light receiving spot S is minimum and placed on both the light receiving surfaces J and K, FIG. 12D is a view showing a state of the light receiving spot at a point x where a focal position slightly outwardly deviates from the light receiving surfaces J and K and a size of the light receiving spot S fits in the light receiving surface J, and FIG. 12E is a view showing a state of the light receiving spot at a point y where a focal position largely outwardly deviates from the light receiving surfaces J and K and a size of the light receiving spot is greatly larger than the light receiving surface J.

### DETAILED DESCRIPTION OF THE INVENTION

Embodiments according to the present invention will now be described hereinafter with reference to the accompanying drawings.

(First Embodiment)

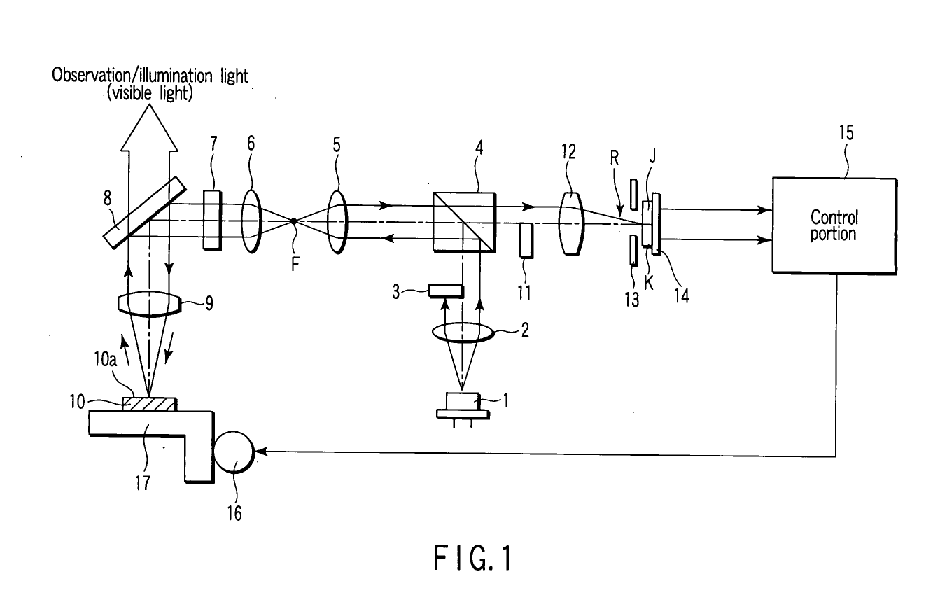

FIG. 1 shows a schematic structure of a focus detection apparatus according to a first embodiment of the present invention.

In FIG. 1, a laser diode (LD) 1 as a light source emits a laser beam having, e.g., an infrared wavelength. A collimator lens 2, a restriction edge 3 (a first light shading portion) and a polarizing beam splitter 4 are arranged on a light path of the laser beam emitted from the laser diode (LD) 1. The collimator lens 2 converts the laser beam emitted from the laser diode (LD) 1 into a parallel light beam. Further, the restriction edge 3 cuts off a half of a restricted parallel light beam (the laser beam). The polarizing beam splitter 4 is configured to reflect the laser beam which is not cut off by the restriction edge 3 and transmit reflected light reflected by a later-described sample 10 therethrough.

A first intermediate image forming lens 5, a second intermediate image forming lens 6, a ¼ wavelength plate 7 and a dichroic mirror 8 are arranged in a reflection light path of the polarizing beam splitter 4.

The first intermediate image forming lens 5 forms an image of the parallel light beam transmitted through the collimator lens 2 at an intermediate image forming point F. The second intermediate image forming lens 6 again turns the laser beam which has been image-formed at the intermediate image forming point F into a parallel light beam. The ¼ wave plate 7 converts the laser beam which has been turned to the parallel light beam into circular polarized light from linear polarized light. The dichroic mirror 8 has characteristics of reflecting an infrared wavelength and transmitting, e.g., visible light therethrough. Infrared light intended for focus detection is inserted into an upper observation optical system (not shown) so that visible light for observation is not affected. The sample 10 mounted on a stage 17 is arranged in a reflection light path of the dichroic mirror 8 through the object lens 9.

A restriction edge 11 (a second light shading portion), a condenser lens 12, a pinhole 13 as a light shading portion constituting a light receiving quantity restricting portion, and a two-split photodetector 14 as a light receiving portion are arranged in a transmission light path of the polarizing beam splitter 4 as seen from the sample 10 side.

The restriction edge 11 assures the other one of the two divided regions on a plane vertical to the optical axis of the object lens 9 (a light beam transmitted through an upper side of the illustrated optical axis), and cuts off the light beam transmitted through a lower side of the illustrated optical axis. The condenser lens 12 condenses the light beam which is not restricted (cut off) by the restriction edge 11. The pinhole 13 has, e.g., a circular aperture set immediately front the two-split photodetector 14. This aperture is provided with the optical axis at the center. A part of light transmitted through the condenser lens 12 is cut off by the pinhole 13. The light transmitted through the pinhole 13 is condensed on the two-split photodetector 14 (a condensing position point R). The two-split photodetector 14 has two light receiving surfaces J and K like the above description. The two-split photodetector 14 has a function of receiving reflected light transmitted through the pinhole 13 and outputting a current signal corresponding to a light quantity.

A control portion 15 is connected with the two-split photodetector 14. A non-illustrated current/voltage conversion circuit is provided in the control portion 15. A current signal output from the two-split photodetector 14 is converted into a voltage signal by the current/voltage conversion circuit. The control portion 15 calculates a focus detection signal based on this voltage signal. It is good enough for the control portion 15 to adjust a focusing mechanism 16 based on this focus detection signal. As a result, the stage 17 on which the sample 10 is mounted moves up and down, and a relative distance of the object lens 9 and the sample 10 is adjusted. Therefore, the sample 10 is moved to a focal position.

A function of the embodiment having such a configuration will now be described.

A laser beam having an infrared wavelength is emitted from the laser diode (LD) 1. This emitted laser beam having the infrared wavelength is limited to a parallel light beam by the collimator lens 2. Further, a half of the leaser beam limited to the parallel light beam is cut off by the restriction edge 3 arranged in the light path. The remaining laser beam which has not been cut off is applied to the polarizing beam splitter 4. Furthermore, the laser beam reflected by the polarizing beam splitter 4 is transmitted through the first intermediate image forming lens 5 to be image-formed at the intermediate image forming point F. Moreover, the laser beam is transmitted through the second intermediate image forming lens 6 to turn to a parallel light beam, then transmitted through the ¼ wave plate 7, and thereafter applied to the dichroic mirror 8.

The dichroic mirror 8 has characteristics of reflecting the infrared wavelength and transmitting visible light therethrough, and the laser beam reflected toward the lower side by the dichroic mirror 8 is transmitted through the object lens 9 and condensed on the surface 10a of the sample 10.

Reflected light reflected by the surface 10a of the sample 10 is again transmitted through the object lens 9, reflected by the dichroic mirror 8, and transmitted through the ¼ wave plate 7, the second intermediate image forming lens 6, the intermediate image forming point F, the first intermediate image forming lens 5 and the polarizing beam splitter 4. In the reflected light transmitted through the polarizing beam splitter 4, a half of the reflected light is cut off by the restriction edge 11, and the remaining half of the reflected light is condensed by the condenser lens 12. The reflected light transmitted through the condenser lens 12 and further transmitted through the pinhole 13 is condensed on the two-split photodetector 14 (the condensing position R). A image quality (condensing quality) of the reflected light in this case differs depending on, e.g., a relative distance of the sample 10 and the object lens 9, characteristics of the object lens (e.g., a type of the object lens 9 (a magnifying power of the object lens 9 and focal length)), and characteristics of the sample 10 (e.g., a reflection factor of the sample 10 or a shape of the surface 10a of the sample 10). Therefore, the pinhole 13 restricts a quantity of light detected by the two-split photodetector 14, thereby adjusting a range of a later-described section Q2.

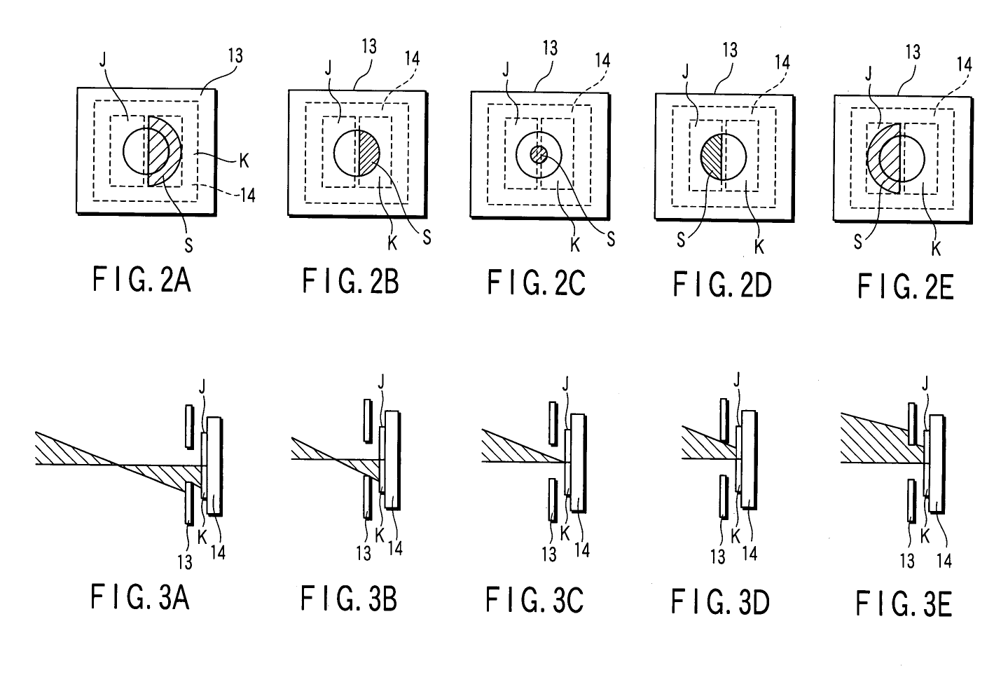

FIGS. 2A to 2E show states of a spot of reflected light on the pinhole 13, and FIGS. 3A to 3E show states where the reflected light transmitted through the pinhole 13 is condensed on light receiving surfaces of the two-split photodetector 14. Particulars of each drawing will now be described.

FIG. 2A shows a state of a light receiving spot S when a focal position largely inwardly deviates from the light receiving surfaces of the two-split photodetector 14, and a size of the light receiving spot S is larger than the pinhole 13. In this case, as shown in FIG. 3A, the pinhole 13 cuts off a part of the light receiving spot S to restrict a light beam which enters the two-split photodetector 14, and the light beam transmitted through the pinhole 13 is detected by the light receiving surface K.

FIG. 2B shows a state of the light receiving spot S when a focal position slightly inwardly deviates from the light receiving surfaces of the two-split photodetector 14, and a size of the light receiving spot S fits in the pinhole 13. In this case, as shown in FIG. 3B, the pinhole 13 allows transmission of all of the light receiving spot S, and a light beam transmitted through the pinhole 13 is detected by the light receiving surface K.

FIG. 2C shows a state of the light receiving spot S when a focal position is placed on the light receiving surfaces of the two-split photodetector 14, and the light receiving spot S has a minimum size and runs through a central part of the pinhole 13. In this case, as shown in FIG. 3C, the pinhole 13 allows transmission of all of the light receiving spot S, and a light beam transmitted through the pinhole 13 is detected by the light receiving surfaces J and K.

FIG. 2D shows a state of the light receiving spot S when a focal position slightly outwardly deviates from the light receiving surfaces of the two-split photodetector 14, and a size of the light receiving spot S fits in the pinhole 13. In this case, as shown in FIG. 3D, the pinhole 13 allows transmission of all of the light receiving spot S, and a light beam transmitted through the pinhole 13 is detected by the light receiving surface J.

Moreover, FIG. 2E shows a state of the light receiving spot S when a focal position largely deviates from the light receiving surfaces of the two-split photodetector 14, and a size of the light receiving spot S is larger than the pinhole 13. In this case, as shown in FIG. 3E, the pinhole 13 cuts off a part of the light receiving spot S to restrict a light beam which enters the two-split photodetector 14, and the light beam transmitted through the pinhole 13 is detected by the light receiving surface J.

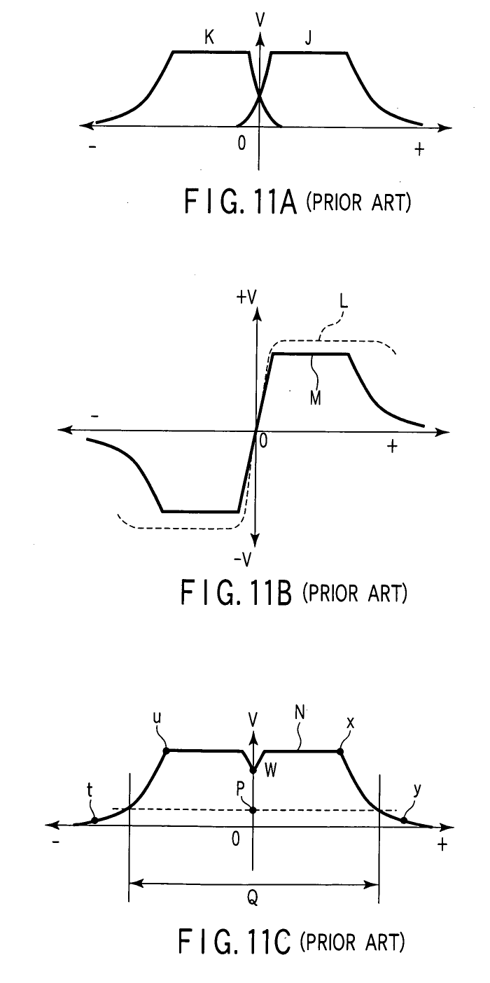

As described above, the two-split photodetector 14 outputs a current signal corresponding to a quantity of light detected by each of the light receiving surfaces J and K. The current signal output from each of these light receiving surfaces J and K is transmitted to the control portion 15 and converted into a voltage signal by the non-illustrated current/voltage conversion circuit. The control portion 15 outputs this signal as a voltage signal corresponding to the light receiving quantity. In this case, as described above, characteristics of changes in the voltage signals JS and KS shown in FIG. 11A are obtained, and a calculation is performed with respect to these voltage signals JS and KS. Signal characteristics shown in FIG. 11B are acquired from a result of this calculation. Additionally, a focus detection signal is obtained from the signal characteristics. In FIG. 11B, a doted line L shows signal characteristics obtained from a result of a calculation (JS−KS)/(JS+KS). A solid line M indicates signal characteristics obtained from a result of a calculation (JS−KS). Each of these two signal characteristics has an S-like shape as shown in the drawing, a focus detection signal is acquired based on a zero cross signal of the signal characteristics L and M having the S-shaped characteristics, thereby calculating a focal position from the focus detection signal.

Additionally, based on this result, the control portion 15 controls the focusing mechanism 16, and the stage 17 is thereby moved up and down so that the sample 10 is moved to the focal position.

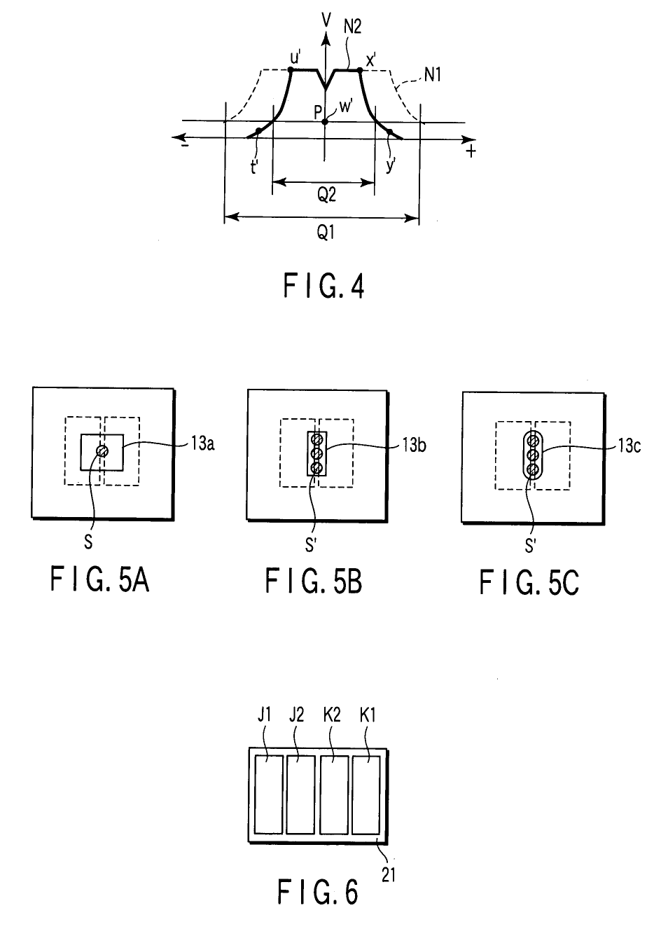

FIG. 4 shows signal characteristics obtained from a result of adding the voltage signals JS and KS in the form of a solid line N2. In this case, respective points t′, u′, w′, x′ and y′ on the solid line N2 correspond to the description of FIGS. 2A to 2E and FIGS. 3A to 3E. When a focal position largely inwardly deviates from the light receiving surfaces of the two-split photodetector 14 (corresponding to the point t′, see FIG. 2A), a part of the light receiving spot S is cut off by the pinhole 13 as shown in FIG. 3A, and a light beam which enters the two-split photodetector 14 is restricted. As a result, a voltage signal corresponding to a quantity of light detected by the two-split photodetector 14 is suddenly decreased from the point u′. Likewise, when a focal position largely outwardly deviates from the light receiving surfaces of the two-split photodetector 14 (corresponding to the point y′, see FIG. 2E), a part of the light receiving spot S is cut off by the pinhole 13 as shown in FIG. 3E, and a light beam which enters the two-split photodetector 14 is restricted. As a result, a voltage signal corresponding to a quantity of light detected by the two-split photodetector 14 is suddenly decreased from the point x′.

As described above, a range equal to or above a voltage level P in the signal characteristics N2 is detected, and this range, i.e., a range of a section Q2 at a position of the sample 10 represented by the horizontal axis is set as a focal point proximity range. As a result, the focal point proximity range (the section Q2) can be considerably narrowed as compared with a case where the pinhole 13 described in conjunction with FIG. 11 is not inserted (N1, Q1). That is, inserting the pinhole 13 in the light path can obtain a relationship of Q2<Q1.

As a result, according to this embodiment, the focusing mechanism 16 can be driven at a low speed in the focal point proximity range (the section Q2). In other ranges, i.e., outside the focal point proximity range (the section Q2), driving the focusing mechanism 16 at a high speed can shorten a section in which the focusing mechanism 16 is driven at a low speed. As a result, focus detection can be performed with a high accuracy in a shorter time.

In this case, when a diameter of the pinhole 13 is increased, a range (a width) of Q2 is thereby enlarged. Further, when the diameter of the pinhole 13 is decreased, the range (the width) of Q2 is thereby reduced. Therefore, in this embodiment, the range (the width) of Q2 can be arbitrarily changed in accordance with the diameter of the pinhole 13.

As a result, in this embodiment, a section where the focusing mechanism 16 is driven at a low speed for accurate focusing (the section Q2) can be suppressed to a minimum range. Highly accurate focus detection can be performed at a high speed (in a short time) in accordance with, e.g., characteristics of the object lens 9 and characteristics of the sample 10.

It is to be noted that the pinhole 13 is a circular hole in the foregoing embodiment, but the present invention is not restricted thereto. The pinhole 13 may have other shapes. For example, the pinhole 13 may be such a square hole 13a as shown in FIG. 5A, a rectangular hole 13b shown in FIG. 5B, such an elliptic hole 13c as shown in FIG. 5C or the like. In particular, in a multispot type focus detection apparatus having a plurality of light receiving spots, a rectangular hole 13b (S′ in the drawing) shown in FIG. 5B or a rectangular hole 13c depicted in FIG. 5C is preferable.

Further, the number of the pinhole 13 is not restricted to one. A plurality of pinholes having different sizes may be prepared so that they can be switched in accordance with characteristics of the object lens 9 or characteristics of the sample 10. In this case, it is good enough for the plurality of pinholes to be provided in, e.g., a turret or a slider so that they can be switched. Alternatively, for example, a variable aperture mechanism which electrically or manually continuously changes a size of the aperture of the pinhole may be used for the pinhole. Using these means can arbitrarily change a quantity of light detected by the two-split photodetector. Further, switching of these pinholes may be electrically or manually carried out. As described above, it is needless to say that arbitrarily combining and adjusting these pinholes realize the high-speed accurate focus detection apparatus.

Furthermore, an arrangement position of the pinhole 13 is not restricted to a position immediately front the two-split photodetector 14, and the pinhole 13 can be arranged at the intermediate image forming point F between the first intermediate image forming lens 5 and the second intermediate image forming lens 6.

(Second Embodiment)

A second embodiment according to the present invention will now be described.

Although the description has been given as to the example where the two-split photodetector is used in the first embodiment, a four-split photodetector is used in this second embodiment.

It is to be noted that a schematic structure of a focus detection apparatus according to this second embodiment is the same as that in FIG. 1, thereby making reference to FIG. 1.

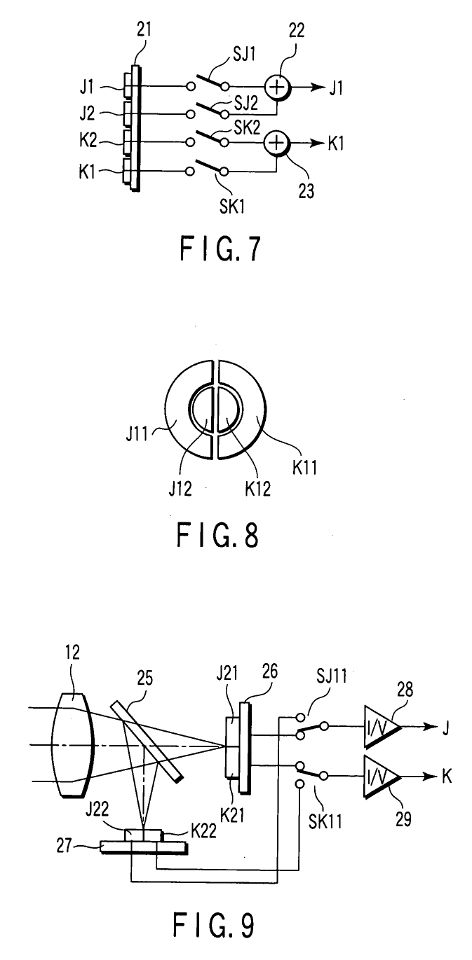

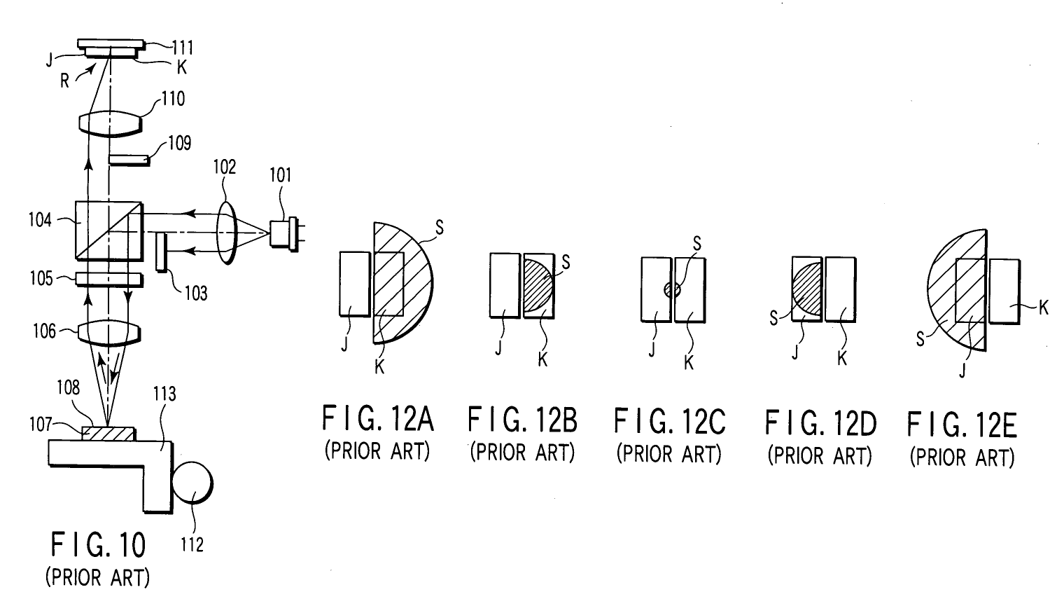

FIG. 6 shows a four-split photodetector 21, and FIG. 7 shows a detection circuit. In this four-split photodetector 21, rectangular light receiving surfaces J1, J2, K1 and K2 are aligned and arranged. Of these surfaces, a current/voltage conversion adder 22 is respectively connected with the light receiving surfaces J1 and J2 through switches SJ1 and SJ2. Moreover, a current/voltage conversion adder 23 is respectively connected with the light receiving surfaces K1 and K2 through switches SK1 and SK2.

The current/voltage conversion adder 22 adds current signals output from the light receiving surfaces J1 and J2 through the switches SJ1 and SJ2 to output an added current signal J1.

The current/voltage conversion adder 23 adds current signals output from the light receiving surfaces K1 and K2 through the switches SK1 and SK2 to output an added current signal K1.

Further, the switches SJ1 and SJ2 and the switches SK1 and SK2 can be changed over in accordance with characteristics of the sample 10 and a size of the light receiving spot S corresponding to characteristics of the object lens 9 like the first embodiment.

For example, in case of increasing a focal point proximity range in accordance with characteristics of the object lens 9 and characteristics of the sample 10 (when the light receiving spot S is large) (Q1 shown in FIG. 4), the switches SJ1 and SJ2 and the switches SK1 and SK2 are all turned on, and current signals output from the light receiving surfaces J1 and J2 are output to the current/voltage conversion adder 22 whilst current signals output from the light receiving surfaces K1 and K2 are output to the current/voltage conversion adder 23.

On the contrary, in case of narrowing a focal point proximity range in accordance with characteristics of the object lens 9 and characteristics of the sample 10 (when the light receiving spot S is small) (Q2 shown in FIG. 4), the switches SJ2 and SK2 are closed and the switches SJ1 and SK1 are turned off so that current signals output from the light receiving surfaces J2 and K2 alone are output to the current/voltage conversion adders 22 and 23. Furthermore, the added current signals J1 and K1 output from the current/voltage conversion adders 22 and 23 at this time are supplied to the above-described control portion 15, and converted into a voltage signal by the current/voltage conversion circuit, thereby obtaining signal characteristics shown in FIG. 4.

When all of the switches SJ1 and SJ2 and the switches SK1 and SK2 are turned on, signal characteristics obtained by the control portion 15 can be represented by a broken line N1 in FIG. 4. When the switches SJ2 and SK2 are turned on and the switches SJ1 and SK1 are turned off, signal characteristics obtained by the control portion 15 can be represented by a solid line N2 shown in FIG. 4.

In this embodiment, ON/OFF of the switches SJ1 and SJ2 and the switches SK1 and SK2 is selected in accordance with characteristics of the object lens 9 and characteristics of the sample 10. As a result, signal characteristics can be changed to arbitrarily set a focal point proximity range (the section Q2), and hence a section in which low-speed driving is performed can be adjusted. As described above, in this embodiment, the focal point proximity range can be adjusted in accordance with characteristics of the object lens 9 and characteristics of the sample 10, thus stably effecting accurate focus detection at a high speed (in a short time).

It is to be noted that the four-split photodetector 21 is not restricted to a shape in which the rectangular light receiving surfaces J1, J2, K1 and K2 are aligned as shown in FIG. 6, and it may have a shape in which two semicircular light receiving surfaces J12 and K12 and two arc-shaped light receiving surfaces J11 and K11 are concentrically arranged as shown in FIG. 8. Of course, it may have any other shape as long as it is a four-split shape. Moreover, although the above has described the four-split photodetector 21, the present invention is not restricted thereto, and applying a multi-split photodetector having many light receiving surfaces, e.g., a six-split photodetector or an eight-split photodetector and switches corresponding to the number of photodetectors can allow stable execution of accurate focus detection at a high speed (in a short time) without being affected by characteristics of the object lens 9 and characteristics of the sample 10.

(Third Embodiment)

A third embodiment according to the present invention will now be described.

In this case, a schematic configuration of an entire focus detection apparatus according to this third embodiment is the same as that shown in FIG. 1. Therefore, a schematic configuration of a primary part alone is shown, and other parts will be described in conjunction with FIG. 1.

FIG. 9 shows a schematic configuration of a primary part of a focus detection apparatus according to the third embodiment. In this case, a beam splitter 25 is arranged behind a condenser lens 12. The beam splitter 25 may be a half mirror. Additionally, a two-split photodetector 26 having relatively wide light receiving surfaces J21 and K21 is arranged in a transmission light path of this beam splitter 25, and a two-split photodetector 27 having relatively narrow light receiving surfaces J22 and K22 is arranged in a reflection light path of the same.

In the two-split photodetector 26, the light receiving surface J21 is connected with one contact point of a switch SJ11, and the light receiving surface K21 is connected with one contact point of a switch SK11. Additionally, in the two-split photodetector 27, the light receiving surface J22 is connected with the other contact point of the switch SJ11, and the light receiving surface K22 is connected with the other contact point of the switch SK11. Further, a switching contact point of the switch SJ11 is connected with a current/voltage converter 28, and a switching contact point of the switch SK11 is connected with a current/voltage converter 29. These current/voltage converters 28 and 29 are configured to convert current signals into voltage signals and respectively output voltage signals J and K.

Furthermore, the switches SJ11 and SK11 are changed over in accordance with characteristics of the object lens 9 and characteristics of the sample 10.

For example, in case of increasing a focal point proximity range in accordance with characteristics of the object lens 9 and characteristics of the sample 10 (a light receiving spot S is large), each switch is changed over to the two-split photodetector 26 side (this state is shown in the drawing). On the contrary, in case of narrowing a focal point proximity range in accordance with characteristics of the object lens 9 and characteristics of the sample 10 (the light receiving spot S is small), each switch is changed over to the two-split photodetector 27 side.

Moreover, a current signal output from the two-split photodetector 26 side is converted into a voltage signal by the current/voltage converter 28 and supplied to a control portion 15. Additionally, signal characteristics shown in FIG. 4 are obtained.

Likewise, a current signal output from the two-split photodetector 27 is converted into a voltage signal by the current/voltage converter 29 and supplied to the control portion 15. Further, the signal characteristics shown in FIG. 4 are obtained.

In this case, when the switches SJ11 and SK11 are changed over to the two-split photodetector 26 side, signal characteristics obtained by the control portion 15 are represented by the broken line N1 depicted in FIG. 4. On the other hand, when the switches SJ11 and SK11 are changed over to the two-split photodetector 27 side, signal characteristics obtained by the control portion 15 are represented by the solid line N2 shown in FIG. 4.

For example, a size of the light receiving spot S differs depending on characteristics of the object lens 9 and characteristics of the sample 10. Therefore, in this embodiment, ON/OFF of the switches SJ11 and SK11 is changed over in accordance with characteristics of the object lens 9 and characteristics of the sample 10. As a result, signal characteristics can be changed to arbitrarily set a focal distance proximity range, thereby adjusting a section in which low-speed driving is performed. As described above, a focal point proximity range can be adjusted in accordance with characteristics of the object lens 9 and characteristics of the sample 10, thus stably effecting accurate focus detection at a high speed (in a short time).

It is to be noted that the light path is divided into two by the beam splitter 25 in the foregoing embodiment, but the present invention is not restricted thereto, and the light path can be divided into three or more so that two-split photodetectors having different light receiving areas can be arranged in respective light paths. Furthermore, in the foregoing embodiment, although the above has described the example in which the two-split photodetector 26 having the relatively wide light receiving surfaces J21 and K21 and the two-split photodetector 27 having the relatively narrow light receiving surfaces J22 and K22 are arranged in the light paths divided by the beam splitter 25 in the foregoing embodiment, a focus detection apparatus having the pinholes of different sizes described in conjunction with the first embodiment may be arranged in place of these two-split photodetectors 26 and 27. Moreover, light reception of both the photodetectors may be calculated to perform focus detection without changing over the switches.

Besides, the present invention is not restricted to the foregoing embodiments, and modifications may be carried out without changing the scope of the invention on embodying stages.

Additionally, the foregoing embodiments include inventions on various stages, and various inventions can be extracted by appropriately combining a plurality of disclosed structural requirements. For example, when the problems described in the section “problems to be solved by the invention” can be solved and the effects mentioned in the section “effects of the invention” are obtained even if some structural requirements are eliminated from all structural requirements described in embodiments, a structure in which these structural requirements are eliminated can be extracted as the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A focus detection apparatus in which a sample is irradiated with light emitted from a light source along one of two divided regions on a plane vertical to an optical axis of an object lens, light reflected from the sample along the other region is detected by a photodetector having a plurality of light receiving surfaces, and focus detection is performed based on a quantity of light detected by the plurality of light receiving surfaces of the photodetector, the focus detection apparatus comprising:
a restricting portion which restricts a light quantity of photodetector detects the light of reflected light from the sample.

2. The focus detection apparatus according to claim 1, wherein the restricting portion is arranged at an intermediate image forming position on a light path of the reflected light or near the light receiving surfaces of the photodetector.

3. The focus detection apparatus according to claim 1, wherein the restricting portion includes a light shading portion which restricts a light receiving range of the plurality of light receiving surfaces which receive the reflected light from the sample.

4. The focus detection apparatus according to claim 3, wherein the light shading portion has a light shading member and an aperture.

5. The focus detection apparatus according to claim 4, wherein the aperture includes one of a circular shape, an elliptic shape, a square shape and a rectangular shape.

6. The focus detection apparatus according to claim 3, wherein the light shading portion has a pinhole.

7. The focus detection apparatus according to claim 3, wherein the light shading portion is configured to change a light shading range in which the reflected light is cut off.

8. The focus detection apparatus according to claim 7, wherein the light shading portion has a plurality of light shading members having apertures of different sizes, and
the light shading portion is configured to switch the plurality of light shading members.

9. The focus detection apparatus according to claim 8, wherein the light shading portion has a turret which arranges one of the plurality of light shading members on an optical axis of the reflected light.

10. The focus detection apparatus according to claim 8, wherein the light shading portion has a slider mechanism which arranges one of the plurality of light shading members on an optical axis of the reflected light.

11. The focus detection apparatus according to claim 8, wherein the aperture includes one of a circular shape, an elliptic shape, a square shape and a rectangular shape.

12. The focus detection apparatus according to claim 7, wherein the light shading portion has a variable diaphragm which is configured to change a size of the aperture.

13. The focus detection apparatus according to claim 7, wherein the light shading portion varies the light shading range of light shading portion in accordance with characteristics of the object lens, a relative distance of the object lens and the sample and characteristics of the sample.

14. The focus detection apparatus according to claim 3, wherein the light shading portion is arranged at an intermediate image forming position on a light path of the reflected light or near the light receiving surfaces of the photodetector.

15. The focus detection apparatus according to claim 1, wherein the photodetector has at least four light receiving surfaces.

16. The focus detection apparatus according to claim 15, wherein the restricting portion selects one of the light receiving surfaces in accordance with a light beam diameter of the reflected light, thereby restricting a quantity of light detected by the photodetector.

17. The focus detection apparatus according to claim 16, wherein the photodetector is configured to switch the two or more light receiving surfaces in accordance with a light beam diameter of the reflected light transmitted through the light shading portion.

18. The focus detection apparatus according to claim 16, wherein the restricting portion selectively switches the light receiving surfaces in accordance with characteristics of the object lens and characteristics of the sample.

19. The focus detection apparatus according to claim 16, wherein the restricting portion includes a switching portion which switches ON/OFF of the light receiving surfaces.

20. The focus detection apparatus according to claim 1, having:
a light beam splitter which divides a light path of the reflected light from the sample to the restricting portion into a plurality of light paths; and
a plurality of photodetectors which are respectively arranged in the divided light paths.

21. The focus detection apparatus according to claim 20, wherein the restricting portion has light shading members which are respectively provided in the plurality of photodetectors and have apertures of different sizes.

22. The focus detection apparatus according to claim 20, wherein the plurality of photodetectors have light receiving surfaces having different light receiving ranges, and
the restricting portion switches one of the photodetectors on which the reflected light is detected, thereby restricting a quantity of light detected by the photodetector.

23. The focus detection apparatus according to claim 1, wherein the restricting portion restricts a quantity of light detected by the photodetector in accordance with a image quality of reflected light condensed on light receiving surface of photodetector.

24. The focus detection apparatus according to claim 1, wherein the restricting portion restricts a quantity of light detected by the photodetector in accordance with characteristics of the object lens.

25. The focus detection apparatus according to claim 1, wherein the restricting portion restricts a quantity of light detected by the photodetector in accordance with characteristics of the sample.

26. A focus detection apparatus comprising:
a light source which emits a light;
a collimating member which converts the light into a parallel light beam;
a light shading portion which cut off a half of the parallel light beam around an optical axis;
a object lens which condenses the parallel light beam to the sample;
a condensing optical system which condenses the light which has reflected from the sample ,which has not been cut off by the light shading portion through the object lens 9;
a photodetector which is arranged at a light condensing position of the condensing optical system, has a plurality of light receiving surfaces provided thereto, and detects the light condensed by the condensing optical system on the light receiving surfaces;
a focus detection portion which is detected focal based on the quantity of light detected by the photodetector
a first light path along which the light emitted from the light source reaches the sample;
a second light path along which the light reflected by the sample reaches the photodetector through the condensing optical system;
a beam splitter which reflects or transmits therethrough the light which has not been cut off by the light shading portion in the light path, and transmits therethrough or reflects the light which has entered through the object lens in the second light path; and
a restricting portion which is provided at an intermediate image forming position of the condensing optical system or near the photodetector and restricts a light detecting quantity of the light detected on the plurality of light receiving surfaces.

27. The focus detection apparatus according to claim 1, wherein the restricting portion restricts a quantity of light detected by the photodetector in accordance with at least one of characteristics of the object lens and characteristics of the sample.
